(19) United States
(12) Patent Application Publication
(10) Pub. No.: US 2022/0019916 A1
(43) Pub. Date: Jan. 20, 2022

(54) APPARATUS AND METHOD FOR RECOMMENDING FEDERATED LEARNING BASED ON TENDENCY ANALYSIS OF RECOGNITION MODEL AND METHOD FOR FEDERATED LEARNING IN USER TERMINAL

(71) Applicant: Electronics and Telecommunications Research Institute, Daejeon (KR)

(72) Inventors: Jin-Hyeok JANG, Sejong-si (KR); Do-Hyung KIM, Daejeon (KR); Jae-Hong KIM, Daejeon (KR); Jae-Yeon LEE, Daejeon (KR); Min-Su JANG, Daejeon (KR); Jeong-Dan CHOI, Daejeon (KR)

(73) Assignee: Electronics and Telecommunications Research Institute, Daejeon (KR)

(21) Appl. No.: 17/109,809

(22) Filed: Dec. 2, 2020

(30) Foreign Application Priority Data
Jul. 16, 2020 (KR) 10-2020-0088120

(51) Int. Cl. G06N 5/04; G06K 9/62; G06N 20/20

(52) U.S. Cl. CPC G06N 5/04; G06N 20/20; G06K 9/6257; G06K 9/6231

(57) ABSTRACT

Disclosed herein are an apparatus and method for recommending federated learning based on recognition model tendency analysis. The method for recommending federated learning based on recognition model tendency analysis in a server device may include analyzing the tendency of a recognition model trained using reinforcement learning by each of multiple user terminals, grouping the multiple user terminals according to the tendency of the recognition model, and transmitting federated-learning group information including information about other user terminals grouped together with at least one of the multiple user terminals.

### CROSS REFERENCE TO RELATED APPLICATION

This application claims the benefit of Korean Patent Application No. 10-2020-0088120, filed Jul. 16, 2020, which is hereby incorporated by reference in its entirety into this application.

### BACKGROUND OF THE INVENTION

### 1. Technical Field

The disclosed embodiment relates to technology for federated learning for exchange among various Artificial Intelligence (AI) networks and reinforcement thereof

### 2. Description of the Related Art

With the development of AI technology, a recognizer capable of enhancing itself or adapting to the environment has emerged. Accordingly, it is expected that individual users or terminals can use a recognizer suitable therefor, rather than sharing the same recognizer.

As a method for realizing a single preferable recognizer by combining a variety of recognizers, there is ‘federated learning’. Here, important issues related to federated learning include protection of private information, minimization of network traffic, and the performance of a consolidated recognizer.

To date, the most widely known method of federated learning has generally been configured such that a main server receives weights from multiple terminals, generates a single consolidated recognizer through calculation of the average of the multiple weights or weight distillation, and redistributes the recognizer obtained as the result of federated learning to the terminals. Additionally, there is a method of sharing the gradient of update or collected data for consolidation, but because too much network traffic results and because shared data may include private information, this method is not used much.

Research on federated learning has been proposed to generate a more generalized recognizer by federating data after enriching data by making entry-level mobile devices, such as mobile phones, collect data suitable for their individual environments. Also, in the case of hospitals, research is oriented towards implementation of a consolidated recognizer by sharing recognizers between hospitals without data leakage in the situation in which data including private information, such as medical data, is prevented from being exposed outside.

However, a general method for federated learning has the following problems.

First, whether shared weights include private information cannot be ensured. The significant advancement of techniques of visualization in deep learning makes it possible to detect data from the structure and weights of a recognizer or to inductively generate data therefrom. With the development of such techniques, it will even be possible to extract private information from the weights and the recognizer.

Next, there is a problem resulting from the development of adversarial attack technology. Various research on technology for detecting vulnerabilities in a recognizer from the recognizer itself or weights thereof and thereby incapacitating the recognizer is underway. A general method in which a main server possesses all weights poses such a risk. Further, because all devices have the same weight, it may be easy to find a way to incapacitate all of the recognizers in such a way that one of the devices analyzes the weight received thereby.

Finally, it is burdensome for a central server to generate a recognizer suitable for all users and distribute the same. Users have their own environments, and each of the users may want his/her recognizer to operate well in his/her environment, rather than smoothly operating in all environments. For example, a recognizer specialized for a home environment does not also need to operate well at a construction site. In order to generate recognizers suitable for individual users in the central server, the central server is required to reinforce a great number of recognizers and redistribute the same.

Despite these problems, the need for and adoption of federated learning are expected to continuously increase with the development of self-learning technology, the development of mobile devices, and increasing demand for personalized AI technology. However, when federated learning is widely used, the above-described potential problems may cause greater problems.

### DOCUMENTS OF RELATED ART

(Patent Document 1) Korean Patent Application Publication No. 10-2019-0103090

### SUMMARY OF THE INVENTION

An object of the embodiment is to reflect the characteristics of individual users through federated learning, thereby enhancing a recognition model in a direction suitable for or desired by the users.

Another object of the embodiment is to prevent leakage of private information that can result from sharing of weights updated through federated learning.

A further object of the embodiment is to detect vulnerabilities from a recognizer trained using federated learning and the weights thereof to thereby prevent the recognizer from being incapacitated.

Yet another object of the embodiment is to relieve a burden that is imposed on a main server when the main server generates and distributes a recognizer suitable for the characteristics of various users for federated learning.

A method for recommending federated learning based on recognition model tendency analysis in a server device according to an embodiment may include analyzing the tendency of a recognition model trained using reinforcement learning by each of multiple user terminals; grouping the multiple user terminals according to the tendency of the recognition model; and transmitting federated-learning group information including information about other user terminals grouped together with at least one of the multiple user terminals.

Here, analyzing the tendency of the recognition model may include transmitting sample data to the user terminal; receiving, from the user terminal, recognition result data of the recognition model to which the sample data is input; and determining the tendency of the recognition model based on the recognition result data.

Here, the sample data may be classified into categories depending on at least one of an environment attribute and a user attribute, transmitting the sample data to the user terminal may be configured to transmit pieces of sample data in the respective categories, the recognition result data may be pieces of recognition result data for the respective pieces of sample data in the respective categories, and determining the tendency of the recognition model may be configured to determine the tendency of the recognition model based on the accuracy of each of the pieces of recognition result data for the respective pieces of sample data in the respective categories.

Here, the tendency of the recognition model may be represented using indicators including at least one of the environment attribute, the user attribute, clarity of input data, clarity of an output result, bias in each output class, and generality.

Here, the federated-learning group information may further include information about the ratio between respective weights of the recognition models of the grouped user terminals to be applied when federated learning is performed.

The method may further include predicting the tendency of the recognition model to be generated through federated learning performed for each federated-learning group, and the federated-learning group information may further include the predicted tendency of the recognition model.

The method may further include receiving the selection of a target tendency of a recognition model according to federated learning from the user terminal, and grouping the multiple user terminals may be configured to select another user terminal to participate in federated learning based on the selected target tendency of the recognition model.

Here, the recognition model may be represented as a point having coordinate values in a space, an axis of which indicates at least one indicator, and grouping the multiple user terminals may be configured to group the multiple user terminals according to the distance between points corresponding to respective recognition models.

A method for federated learning in a user terminal according to an embodiment may include receiving federated-learning group information from a server device; acquiring the weight of the recognition model of an additional user terminal included in the federated-learning group information; and performing federated learning for a recognition model using the acquired weight of the recognition model. The additional user terminal included in the federated-learning group information may be grouped according to the tendency of a recognition model trained using reinforcement learning by the user terminal.

Here, the method for federated learning in the user terminal may further include receiving sample data of each category from the server device, the sample data being classified depending on at least one of an environment attribute and a user attribute; and transmitting result data, output by inputting the sample data of each category to the recognition model, to the server device. The result data may be used to determine the tendency of the recognition model.

Here, the method for federated learning in the user terminal may further include requesting the target tendency of a recognition model according to federated learning from the server device. The federated-learning group information may be information about another user terminal to participate in federated learning based on the target tendency of the recognition model.

Here, the federated-learning group information may further include at least one of information about the ratio between respective weights of recognition models of grouped user terminals to be applied when federated learning is performed and the tendency of a recognition model that is expected to be generated through federated learning performed for each federated-learning group.

Here, the weight of the recognition model may be acquired after the additional user terminal consents to sharing of the weight of the recognition model.

A server device according to an embodiment may include memory in which at least one program is recorded; and a processor for executing the program. The program may perform analyzing the tendency of a recognition model trained using reinforcement learning by each of multiple user terminals, grouping the multiple user terminals according to the tendency of the recognition model, and transmitting federated-learning group information including information about other user terminals grouped together with at least one of the multiple user terminals.

Here, analyzing the tendency of the recognition model may include transmitting sample data to the user terminal; receiving, from the user terminal, recognition result data of the recognition model to which the sample data is input; and determining the tendency of the recognition model based on the recognition result data.

Here, the sample data may be classified into categories depending on at least one of an environment attribute and a user attribute, transmitting the sample data to the user terminal may be configured to transmit pieces of sample data in the respective categories, the recognition result data may be pieces of recognition result data for the respective pieces of sample data in the respective categories, and determining the tendency of the recognition model may be configured to determine the tendency of the recognition model based on the accuracy of each of the pieces of recognition result data for the respective pieces of sample data in the respective categories.

Here, the tendency of the recognition model may be represented using indicators including at least one of the environment attribute, the user attribute, clarity of input data, clarity of an output result, bias in each output class, and generality.

Here, the federated-learning group information may further include information about the ratio between respective weights of recognition models of the grouped user terminals to be applied when federated learning is performed.

Here, the program may further perform predicting the tendency of the recognition model to be generated through federated learning performed for each federated-learning group, and the federated-learning group information may further include the predicted tendency of the recognition model.

Here, the program may further perform receiving the selection of a target tendency of a recognition model according to federated learning from the user terminal, and grouping the multiple user terminals may be configured to select another user terminal to participate in federated learning based on the selected target tendency of the recognition model.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic diagram illustrating a general federated-learning system;

FIG. 2 is a schematic diagram illustrating a federated-learning system according to an embodiment;

FIG. 3 is a schematic block diagram of a server device according to an embodiment;

FIG. 4 is a flowchart for explaining the step of analyzing the tendency of a recognition model trained using reinforcement learning by each of multiple user terminals according to an embodiment;

FIG. 5 is an exemplary view for expressing the tendency of a recognition model according to an embodiment;

FIG. 6 is an exemplary view illustrating prediction of the result of federated learning according to an embodiment;

FIG. 7 is an exemplary view illustrating a coordinate space in which the tendency of a recognition model is represented according to an embodiment;

FIG. 8 is a flowchart for explaining the step of grouping multiple user terminals according to the tendency of a recognition model according to an embodiment;

FIG. 9 is a flowchart for explaining a method for federated learning in a user terminal according to an embodiment; and

FIG. 10 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

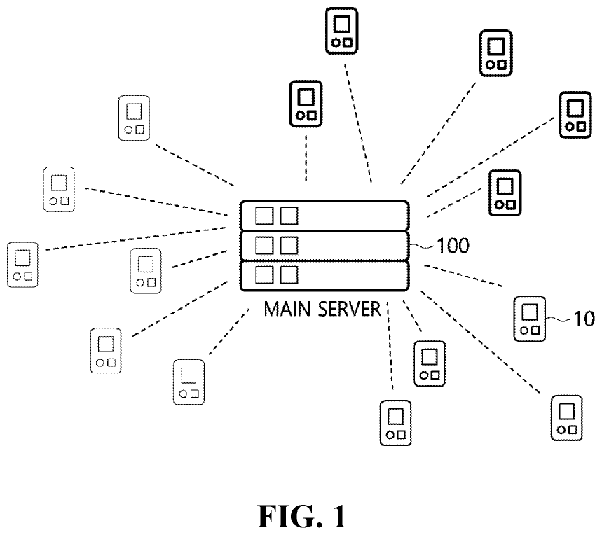

Hereinafter, an apparatus and method according to an embodiment will be described in detail with reference to FIGS. 1 to 10.

FIG. 1 is a schematic diagram illustrating a general federated-learning system.

Referring to FIG. 1, the performance of recent mobile devices, that is, the performance of user terminals 10, has reached a level at which each of the user terminal 10 is capable of training its recognition model by itself. Accordingly, the user terminals 10 each autonomously perform self-reinforcement learning before federated learning, and thus the recognition models thereof are different from each other.

Therefore, a main server 100 at the center acquires the weights of the recognition models, which are different in the respective user terminals 10, and calculates the average of the multiple weights or performs weight distillation, thereby generating a single consolidated recognizer.

In the conventional federated-learning system configured as described above, the main server 100 is required to process the weights received from all of the user terminals 10, which increases the load on the main server 100.

Further, in order to provide a personalized recognition model to each of the user terminals 10, the load on the main server 100 is further increased. For example, when there are 100 user terminals 10, the main server 100 at the center must receive 100 weights and perform the process of combining the weights in different forms desired by the respective user terminals 10 one hundred times in order to perform federated learning. That is, it is almost impossible for a single main server 100 to generate models suitable for all of the individual users.

Therefore, in order to enable local federated learning by sharing weights between grouped user terminals, rather than centralized federated learning performed by a single main server, the present invention proposes an apparatus and method for recommending federated learning based on recognition model tendency analysis and a federated-learning method in a user terminal.

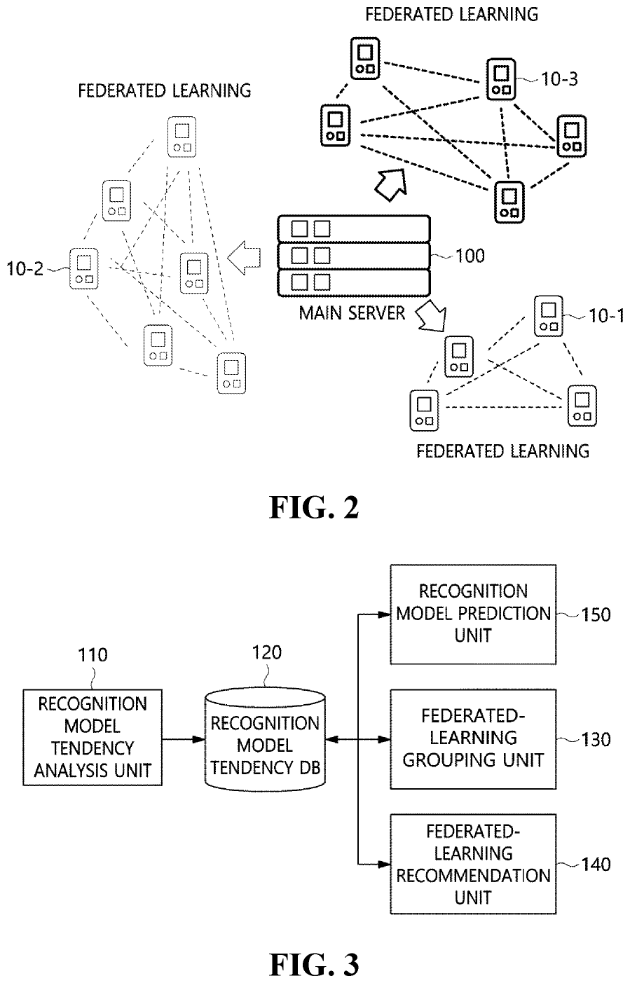

FIG. 2 is a schematic diagram illustrating a federated-learning system according to an embodiment.

Referring to FIG. 2, it can be seen that local federated learning is performed in such a way that each user terminal 10-1, 10-2 or 10-3 directly exchanges data with other user terminals in a federated-learning group to which the user terminal belongs, rather than centralized federated learning performed by a main server 100, as shown in FIG. 1.

Here, the exchanged data may be the weights of recognition models or the data to be input to the recognition model, which are information required for federated learning.

Each of the user terminals 10-1, 10-2 and 10-3 performs federated learning by itself in the direction desired by the user thereof using the exchanged weights of the recognition models or the exchanged data input to the recognition model.

To this end, the main server 100 serves to match a federated-learning group to each of the user terminals 10-1, 10-2 and 10-3 and to recommend the matching federated-learning group to the user terminal such that a recognition model suitable therefor is generated.

Here, according to an embodiment, the main server 100 may match a federated-learning group to each of the user terminals 10-1, 10-2 and 10-3 based on the result of analysis of the tendency of the recognition model thereof, and may then recommend the federated-learning group thereto.

That is, a recognition model recognizes input data, and simultaneously, may be trained through reinforcement learning using the recognized input data, whereby the weight of an artificial neural network may be updated. Accordingly, in the recognition model, the weight thereof may be gradually updated in the direction matching the type of the input data to be recognized. That is, depending on the gradually updated weight, the result of recognition by the recognition model has its own unique disposition, that is, a unique tendency.

Accordingly, a method for recommending federated learning based on analysis of the tendency of a recognition model, which is performed in the main server 100, may include analyzing the tendency of a recognition model trained using reinforcement learning by each of the multiple user terminals, grouping the multiple user terminals according to the tendencies of the recognition models thereof, and transmitting federated-learning group information including information about other user terminals grouped together with at least one of the multiple user terminals.

The method for recommending federated learning based on recognition model tendency analysis in the server device will be described in detail with reference to FIGS. 3 to 8.

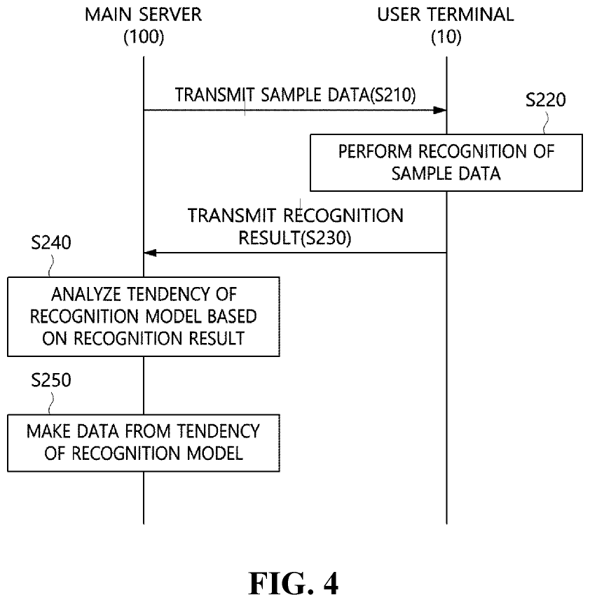

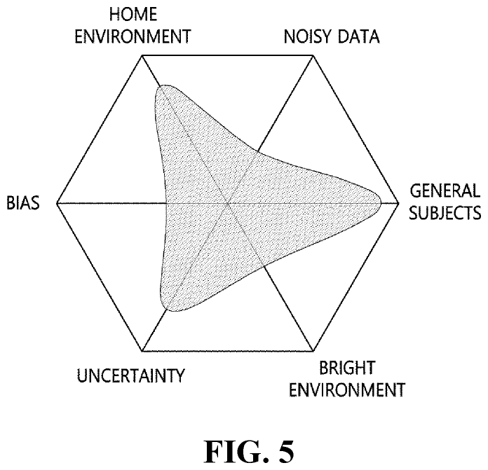

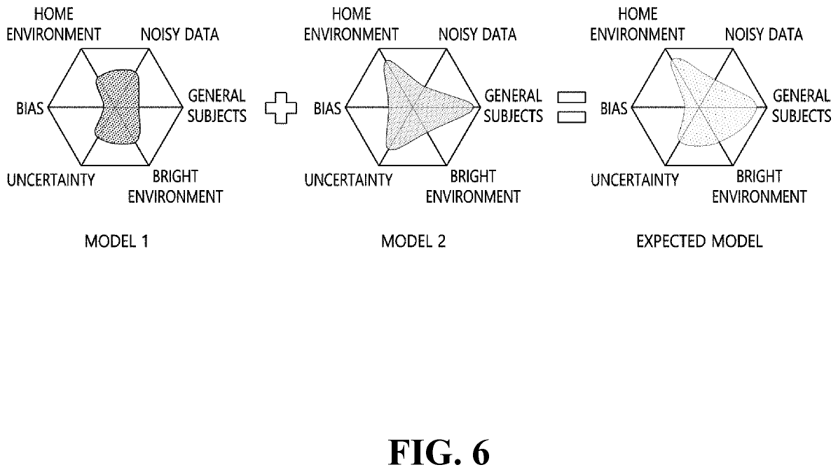

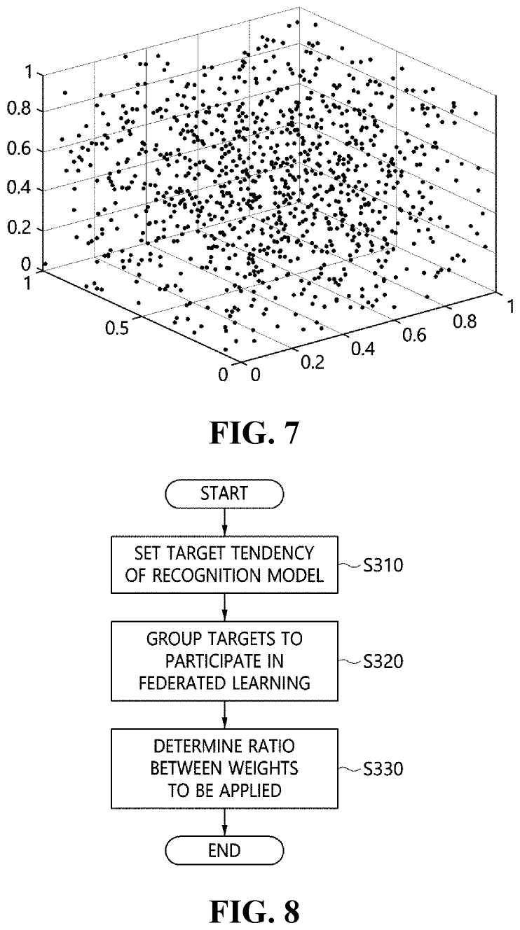

FIG. 3 is a schematic block diagram of a server device according to an embodiment, FIG. 4 is a flowchart for explaining the step of analyzing the tendency of a recognition model trained using reinforcement learning by each of multiple user terminals according to an embodiment, FIG. 5 is an exemplary view for expressing the tendency of a recognition model according to an embodiment, FIG. 6 is an exemplary view illustrating prediction of the result of federated learning according to an embodiment, FIG. 7 is an exemplary view illustrating a coordinate space in which the tendency of a recognition model is represented according to an embodiment, and FIG. 8 is a flowchart for explaining the step of grouping multiple user terminals according to the tendency of recognition models according to an embodiment.

Referring to FIG. 3, the server device 100 for performing a method for recommending federated learning based on recognition model tendency analysis may include a recognition model tendency analysis unit 110, a recognition model tendency DB 120, a federated-learning grouping unit 130, and a federated-learning recommendation unit 140. Additionally, the server device 100 may further include a recognition model prediction unit 150.

The recognition model tendency analysis unit 110 performs the step of analyzing the tendency of a recognition model trained using reinforcement learning by each of multiple user terminals.

That is, the tendencies of the recognition models possessed by the respective user terminals 10-1, 10-2 and 10-3 may be the same at the outset, but each recognition model is steadily reinforced under the influence of the propensities of the user or the factors of the environment in which the recognition model is mainly used, and thus has its own characteristics.

For example, when a recognition model is used in the state in which the location thereof is fixed in a home environment, the recognition model is continuously reinforced through self-learning using home environment data, whereby the recognition result has characteristics more appropriate for a home environment.

Also, in the case of a recognition model installed in a smart terminal, the characteristics of a recognition result may vary depending on the age of the user of the smart terminal.

The easiest method for analyzing the characteristics of a recognition model is to acquire data frequently input to the recognition model and analyze the same. However, such data may include very private information or the like, which may cause a problem of leakage of private information.

As another method for analyzing the characteristics of a recognition model, a method of acquiring the weight of the recognition model may be considered. However, as described above, because there is a concern of leakage of private information through the weights, it is impossible to completely solve the problem of leakage of private information.

Therefore, in order to prevent the leakage of private information, the recognition model tendency analysis unit 110 according to an embodiment analyzes the tendency of a recognition model using sample data that does not incur the leakage of private information.

That is, the main server 100 may collect, in advance, data related to various environments, such as an outdoor environment, a home environment, a work environment, and the like, and data related to users in different age groups, and may use the collected data as sample data. Here, the sample data may be data that is free from the problem of leakage of private information.

Also, the sample data may be classified into categories depending on at least one of the collected environmental attributes and user attributes.

Referring to FIG. 4, the recognition model tendency analysis unit 110 of the main server 100 transmits the sample data to the user terminal 10 at step S210.

The user terminal 10 inputs the sample data to the recognition model possessed thereby and performs recognition of the sample data at step S220. Here, the user terminal 10 may perform recognition of each of the received pieces of sample data in each category.

Then, the user terminal 10 transmits the recognition result data output by the recognition model to the main server 100 at step S230. Here, recognition result data for each of the pieces of sample data in each category may be transmitted.

The recognition model tendency analysis unit 110 of the main server 100 analyzes the tendency of the recognition model at step S240 based on the recognition result data for each of the pieces of sample data transmitted from the user terminal 10. That is, the recognition result data may differ depending on the tendency of the recognition model, even for the same sample data.

Here, the tendency of the recognition model may be determined based on the accuracy of the recognition result data for each piece of sample data in each category. That is, the tendencies of the recognition models may be detected by analyzing the type of the input sample data when high accuracy or clarity of the recognition result data is achieved.

Here, the tendency of the recognition model may be represented using indicators including at least one of an environmental attribute, a user attribute, the clarity of input data, the clarity of an output result, bias in each output class, and generality.

The recognition model tendency DB 120 stores the tendency of the recognition model of each of the user terminals 10, which is analyzed by the recognition model analysis unit 110, at step S250.

Here, data on the tendency of the recognition model of each user terminal 10 may be used after being organized in various forms such that the data is easily manipulated for analysis.

For example, referring to FIG. 5, indicators for representing the tendency include the environment attributes, such as a home environment and a bright environment, the clarity of input data for indicating how clear and noiseless the data used for training is (noisy data), the clarity of a recognition result for indicating whether the recognition result is obvious or ambiguous (uncertainty), the bias in each output class for indicating whether recognition results are evenly distributed among classes, and generality (general subjects). When a polygon, the vertices of which represent the respective indicators, is drawn, the values of the respective indicators may be represented using the distances from the center of the polygon inside the polygon.

Meanwhile, the data on the tendency of the recognition model having the form illustrated in FIG. 5 may be used to predict the recognition model to be obtained as the result of federated learning, as illustrated in FIG. 6.

For example, the tendency of the expected model to be generated as the result of federated learning using model 1 and model 2, each having the tendency illustrated in FIG. 6, may be obtained by calculating the averages of the respective indicator values of the tendency of model 1 and those of model 2. This process may be performed by the recognition model prediction unit 150 illustrated in FIG. 3.

Also, the data on the tendency of the recognition model configured as illustrated in FIG. 5 may facilitate predicting the result of a combination of the recognition models to be used for federated learning for generating a recognition model having the desired tendency.

For example, a recognizer familiar with elderly people and a recognizer familiar with young people are federated, whereby a recognizer suitable for various age groups may be generated. By federating only recognizers for home environments, a more powerful recognizer for home environments may be generated.

Also, the ratio between the current recognizer and federated learning is adjusted, based on which the extent that the current recognizer is changed may be decided. This function is strongly based on tendency analysis, and the functions to be subsequently performed are configured based on this function.

Meanwhile, as another example of the data form for representing the tendency of a recognition model of each user terminal 10, the data on the tendency of a recognition model may be represented in such a way that each recognition model is expressed as a point having coordinate values in the space, the axis of which indicates at least one indicator representing the tendency, as shown in FIG. 7.

Here, the similarity between the tendencies of the recognition models may be determined based on the distance between the points corresponding to the respective recognition models.

Also, a user may set the purpose of the recognition model of the user and the direction in which the recognition model will progress by selecting the same in such a recognition model coordinate space.

Referring again to FIG. 3, the federated-learning grouping unit 130 of the main server 100 performs the step of grouping the multiple user terminals according to the tendencies of recognition models thereof.

Referring to FIG. 8, the federated-learning grouping unit 130 of the main server 100 sets the target tendency of a recognition model at step S310.

Here, the federated-learning grouping unit 130 may receive the selection of the target tendency of the recognition model to be obtained through federated learning from the user terminal 10.

Alternatively, the federated-learning grouping unit 130 may arbitrarily set the collective direction based on the distance between the points corresponding to the recognition models in the recognition model coordinate space, configured as illustrated in FIG. 7.

Then, the federated-learning grouping unit 130 of the main server 100 groups federated-learning targets at step S320 such that they become recognition models having the set target tendency.

Here, after the recognition model to be obtained through federated learning using each of the groups including various recognition models is predicted using the recognition model prediction unit 150, the federated-learning grouping unit 130 of the main server 100 may perform grouping depending on the result of the determination of whether the predicted recognition model matches the target tendency of the recognition model.

Here, the federated-learning grouping unit 130 of the main server 100 may set the ratio between the respective weights of the recognition models of the grouped user terminals to be applied when federated learning is performed at step S330.

Here, the federated-learning grouping unit 130 of the main server 100 may predict the recognition model to be obtained through federated learning using the recognition model prediction unit 150 while variously changing the ratio between the respective weights of the recognition models of the different user terminals applied to federated learning, and may perform grouping depending on the result of the determination of whether the predicted recognition model matches the target tendency.

Referring again to FIG. 3, the federated-learning recommendation unit 140 may transmit federated-learning group information including information about other user terminals grouped together with at least one of the multiple user terminals.

Here, the federated-learning group information may further include information about the ratio between the respective weights of the recognition models of to the grouped user terminals to be applied when federated learning is performed.

Also, the federated-learning group information may further include the tendency of the predicted recognition model.

Accordingly, the user terminals that are grouped together through the above-described method for recommending federated learning based on recognition model tendency analysis in the server device may perform federated learning by sharing weights therebetween.

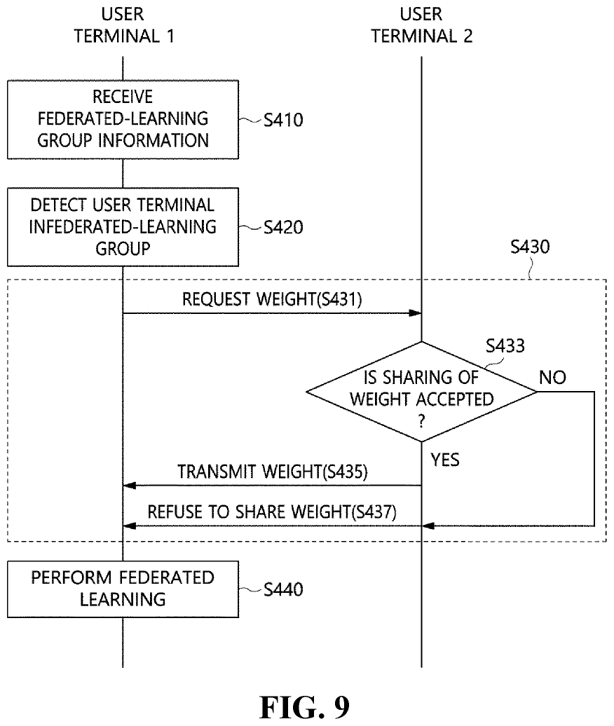

FIG. 9 is a flowchart for explaining a method for federated learning in a user terminal according to an embodiment.

Referring to FIG. 9, user terminal 1 receives federated-learning group information from a main server at step S410.

Here, the federated-learning group information may be information about another user terminal to participate in federated learning based on the target tendency of a recognition model.

Here, the federated-learning group information may further include at least one of information about the ratio between the respective weights of the recognition models of the grouped user terminals to be applied when federated learning is performed and the tendency of the recognition model expected to be generated as the result of federated learning performed for each federated-learning group.

Here, the user terminal 2 included in the federated-learning group information may be grouped together with the user terminal 1 based on the tendency of the recognition model trained using reinforcement learning by the user terminal 1. To this end, as described with reference to FIG. 4, the user terminal 1 may further perform the step of receiving sample data in each category, which is previously classified based on at least one of an environment attribute and a user attribute, from the main server and the step of transmitting result data, output by inputting the sample data in each category to the recognition model, to the server device.

Also, the user terminal 1 may further perform the step of requesting, from the main server, the target tendency of the recognition model to be obtained through federated learning.

The user terminal 1 acquires the weight of the recognition model of the user terminal 2 included in the federated-learning group information at steps S420 and S430.

That is, the user terminal 1 detects the user terminal 2 included in the federated-learning group information at step S420. Here, the user terminal 2 may comprise multiple user terminals. Accordingly, the user terminal 1 may repeatedly perform step S430 as many times as the number of user terminals 2.

Here, the weight of the recognition model may be acquired after obtaining the consent of the user terminal 2 to sharing of the weight of the recognition model.

That is, the user terminal 1 requests the weight of the recognition model from the user terminal 2 at step S431. In response thereto, the user terminal 2 determines whether to consent to sharing of the weight with the user terminal 1 at step S433. This may be determined by asking the user, or may be determined based on predetermined criteria.

When it is determined at step S433 that the request to share the weight is accepted, the user terminal 2 transmits the weight to the user terminal 1 at step S435. Conversely, when it is determined at step S433 that the request to share the weight is not accepted, the user terminal 2 refuses to share the weight at step S437.

The user terminal 1 trains the recognition model using federated learning using the acquired weight of the at least one recognition model at step S440. Here, federated learning for training the recognition model may be adjusted based on at least one of the information about the ratio between the respective weights of the recognition models of the grouped user terminals to be applied when federated learning is performed and the tendency of the recognition model expected to be generated as the result of federated learning performed for each federated-learning group.

Local federated-learning performed in this way may have different orientations.

For example, in order to have the same orientation as the conventional federated learning, federated learning using randomly extracted recognition models is performed multiple times, whereby a recognition model that is nearly the same as in the conventional federated learning may be acquired. This may be represented using the following Equation (1):

y=f(x₁, x₂, x₃, x₄. . . x_{N}) (1)

Here, y denotes the recognition model generated as the result of federated learning, x denotes each local recognition model, and f(.) denotes federated learning. Here, it is assumed that a total of N recognition models is used for federated learning.

When federated learning locally performed according to an embodiment is applied to the randomly extracted local recognition models multiple times, it may be represented using the following Equation (2):

y⁰=xᵢ . . . i=random

y^{t+1}=f(xᵢ, y^{t}) . . . t=1˜T, i=random (2)

Here, t denotes the sequence number of local federated learning, and i may be randomly selected each time.

According to Equation (2), when the sequence number of local federated learning is increased, y^{t} becomes similar to y in the conventional federated learning. Also, when i is selected so as to be suitable for a user, rather than being randomly selected, federated learning may progress in a specific direction. That is, locally performed federated learning according to an embodiment is able not only to perform the function of the conventional federated learning but also to enable federated learning to be performed so as to match the target tendency of a recognition model, which is not provided by the conventional federated learning.

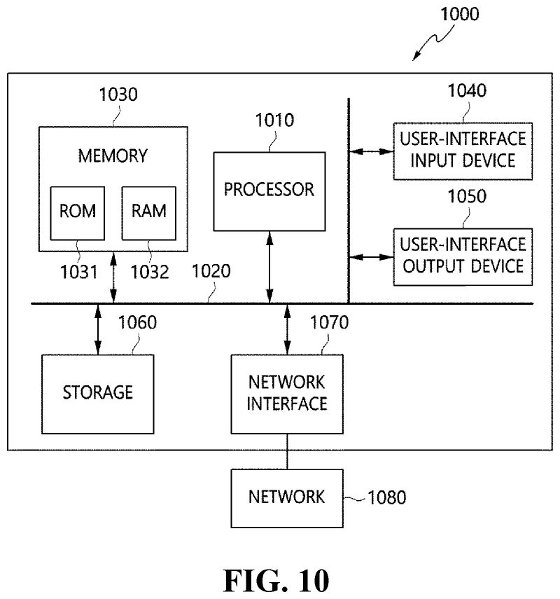

FIG. 10 is a view illustrating a computer system configuration according to an embodiment.

The server device and the user terminal according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to an embodiment, the characteristics of individual users are reflected through federated learning, whereby a personalized recognition model may be enhanced in a direction suitable for or desired by the user.

According to an embodiment, leakage of private information, which can result from sharing of weights updated through federated learning, may be prevented. That is, because weights are shared after obtaining a user's consent to sharing, weights may be shared without concern about problems related to private information.

According to an embodiment, vulnerabilities may be detected from the recognizer trained using federated learning and the weights thereof, and the recognizer may be prevented from being incapacitated.

According to an embodiment, a burden that is imposed on a main server when the main server generates a recognizer suitable for the characteristics of various users and distributes the same for federated learning may be relieved.

According to an embodiment, users may detect the characteristics of their models, and may predict the result of federated learning.

The embodiment is expected to be widely applied with the development and spread of devices.

Although embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for recommending federated learning based on recognition model tendency analysis in a server device, comprising:
analyzing a tendency of a recognition model trained using reinforcement learning by each of multiple user terminals;
grouping the multiple user terminals according to the tendency of the recognition model; and
transmitting federated-learning group information including information about to other user terminals grouped together with at least one of the multiple user terminals.

2. The method of claim 1, wherein analyzing the tendency of the recognition model comprises:
transmitting sample data to the user terminal;
receiving, from the user terminal, recognition result data of the recognition model to which the sample data is input; and
determining the tendency of the recognition model based on the recognition result data.

3. The method of claim 2, wherein:
the sample data is classified into categories depending on at least one of an environment attribute and a user attribute,
transmitting the sample data to the user terminal is configured to transmit pieces of sample data in the respective categories,
the recognition result data is pieces of recognition result data for the respective pieces of sample data in the respective categories, and
determining the tendency of the recognition model is configured to determine the tendency of the recognition model based on accuracy of each of the pieces of recognition result data for the respective pieces of sample data in the respective categories.

4. The method of claim 3, wherein the tendency of the recognition model is represented using indicators including at least one of the environment attribute, the user attribute, clarity of input data, clarity of an output result, bias in each output class, and generality.

5. The method of claim 4, wherein the federated-learning group information further includes information about a ratio between respective weights of the recognition models of the grouped user terminals to be applied when federated learning is performed.

6. The method of claim 5, further comprising:
predicting a tendency of a recognition model to be generated through federated learning performed for each federated-learning group,
wherein the federated-learning group information further includes the predicted tendency of the recognition model.

7. The method of claim 6, further comprising:
receiving a selection of a target tendency of a recognition model according to federated learning from the user terminal,
wherein grouping the multiple user terminals is configured to select another user terminal to participate in federated learning based on the selected target tendency of the recognition model.

8. The method of claim 6, wherein:
the recognition model is represented as a point having coordinate values in a space, an axis of which indicates at least one indicator, and
grouping the multiple user terminals is configured to group the multiple user terminals according to a distance between points corresponding to respective recognition models.

9. A method for federated learning in a user terminal, comprising:
receiving federated-learning group information from a server device;
acquiring a weight of a recognition model of an additional user terminal included in the federated-learning group information; and
performing federated learning for a recognition model using the acquired weight of the recognition model,
wherein the additional user terminal included in the federated-learning group information is grouped according to a tendency of a recognition model trained using reinforcement learning by the user terminal.

10. The method of claim 9, further comprising:
receiving sample data of each category from the server device, the sample data being classified depending on at least one of an environment attribute and a user attribute; and
transmitting result data, output by inputting the sample data of each category to the recognition model, to the server device,
wherein the result data is used to determine the tendency of the recognition model.

11. The method of claim 9, further comprising:
requesting a target tendency of a recognition model according to federated learning from the server device,
wherein the federated-learning group information is information about another user terminal to participate in federated learning based on the target tendency of the recognition model.

12. The method of claim 9, wherein the federated-learning group information further includes at least one of information about a ratio between respective weights of recognition models of grouped user terminals to be applied when federated learning is performed and a tendency of a recognition model that is expected to be generated through federated learning performed for each federated-learning group.

13. The method of claim 9, wherein the weight of the recognition model is acquired after the additional user terminal consents to sharing of the weight of the recognition model.

14. A server device, comprising:
memory in which at least one program is recorded; and
a processor for executing the program,
wherein the program performs
analyzing a tendency of a recognition model trained using reinforcement learning by each of multiple user terminals,
grouping the multiple user terminals according to the tendency of the recognition model, and
transmitting federated-learning group information including information about other user terminals grouped together with at least one of the multiple user terminals.

15. The server device of claim 14, wherein analyzing the tendency of the recognition model comprises:
transmitting sample data to the user terminal;
receiving, from the user terminal, recognition result data of the recognition model to which the sample data is input; and
determining the tendency of the recognition model based on the recognition result data.

16. The server device of claim 15, wherein:
the sample data is classified into categories depending on at least one of an environment attribute and a user attribute,
transmitting the sample data to the user terminal is configured to transmit pieces of sample data in the respective categories,
the recognition result data is pieces of recognition result data for the respective pieces of sample data in the respective categories, and
determining the tendency of the recognition model is configured to determine the tendency of the recognition model based on accuracy of each of the pieces of recognition result data for the respective pieces of sample data in the respective categories.

17. The server device of claim 16, wherein the tendency of the recognition model is represented using indicators including at least one of the environment attribute, the user attribute, clarity of input data, clarity of an output result, bias in each output class, and generality.

18. The server device of claim 17, wherein the federated-learning group information further includes information about a ratio between respective weights of recognition models of the grouped user terminals to be applied when federated learning is performed.

19. The server device of claim 17, wherein:
the program further performs predicting a tendency of a recognition model to be generated through federated learning performed for each federated-learning group, and
the federated-learning group information further includes the predicted tendency of the recognition model.

20. The server device of claim 17, wherein:
the program further performs receiving a selection of a target tendency of a recognition model according to federated learning from the user terminal, and
grouping the multiple user terminals is configured to select another user terminal to participate in federated learning based on the selected target tendency of the recognition model.
